(19) United States
(12) Patent Application Publication
(10) Pub. No.: US 2024/0232234 A9
(43) Pub. Date: Jul. 11, 2024

(54) USER INTERFACE FOR PROVIDING AN ENTITY RELATIONSHIP DIAGRAM

(71) Applicant: Kinaxis Inc., Ottawa (CA)

(72) Inventors: Christopher BURT, Ottawa (CA); Ryan Christopher MCCLUSKEY, Ottawa (CA); Graham ANDREWS, Ottawa (CA); Matthew S. CHMIEL, Ottawa (CA); Douglas BURRILL, Ottawa (CA)

(21) Appl. No.: 18/489,465

(22) Filed: Oct. 18, 2023

Related U.S. Application Data
(60) Provisional application No. 63/417,499, filed on Oct. 19, 2022.

(51) Int. Cl. G06F 16/28; G06F 16/22; G06F 16/2452; G06F 16/2457

(52) U.S. Cl. CPC G06F 16/288; G06F 16/2246; G06F 16/2452; G06F 16/24573

(57) ABSTRACT

An interactive entity relationship diagram discovers explicitly defined relationships, and also dynamically discovers and represents non-explicit relationships. This entails calculating metadata and references by parsing the queries. An entity relationship diagram thereby provides novel visibility on the queries being related as the basis for a user interface which integrates several configuration utilities.

This application claims priority from U.S. Provisional Ser. No. 63/417,499, filed Oct. 19, 2022, which is incorporated in its entirety herein by reference.

### BACKGROUND

In some software environments, a user creates data applications by means of user-defined database queries. These queries may reference each other in their syntax and formulas. Those references may span multiple documents or containers where the queries are defined. Several challenges arise for users, a few of which are outlined below.

Maintaining an application defined by potentially hundreds of dynamically related queries can quickly become unwieldy. Users need to follow chains or branches of functionality distributed across many entities, make changes with awareness of the impact, and avoid redundancy by discovering reusable structures, for example.

Configuring queries while continually reviewing the data results they produce may be difficult or time-consuming depending on the user-interface (UI) environment. This is compounded in a system where many subcomponents are executed to prepare final results for consumption in the application. Users need visibility at each step to locate and correct faults.

In complex applications, technical performance is of paramount value. Users need to create efficient structures to achieve good performance in the final product. Evaluating the performance among sub-components of query structures, and identifying and ameliorating performance bottlenecks in those structures, maybe be difficult or time-consuming depending on the UI environment.

### BRIEF SUMMARY

To address user challenges, an entity relationship diagram can be constructed. In addition to explicitly defined relationships, the diagram may also dynamically discover and represent non-explicit relationships. This entails calculating metadata and references by parsing the queries. An entity relationship diagram can thereby provide novel visibility on the queries being related as the basis for a UI which integrates several configuration utilities.

Comprehension and workflow efficiency for the user can be augmented by a system providing an interactive entity relationship diagram representing these queries. Rather than a view of a static database with only definite relationships, such a diagram can also dynamically discover and represent non-explicit relationships. Producing such a diagram entails calculating metadata and references by parsing the queries.

An entity relationship diagram can achieve novel advantages for users by integrating and augmenting several utilities:

Maintaining an application defined by potentially hundreds of dynamically related queries can quickly become unwieldy; an entity relationship diagram can automate the discovery of relationships and provide focused views for making changes with awareness of the impact.

An entity relationship diagram may enable users to select parts of the query structure to run during configuration and see the results; each sub-component of the structure may be evaluated as the user builds up a final result. Traditionally, where the results have errors, identifying faults in the calculations or logic can be daunting; an entity relationship diagram enables rapid exploration of sub-queries and the resulting data to facilitate corrections.

During configuration of data modelling and presentation applications, users often need to create efficient structures to achieve good technical performance in the final product. While executing sub-components, users can retrieve metrics about query calculation, and the graph can overlay performance data for each component in the query. Performance bottlenecks can be revealed immediately in the same environment where the structure is visualized and the configuration is affected.

In one aspect, a computer-implemented method can include: determining, by a processor, one or more query relationships for a main query, formula and/or expression; displaying, by the processor, a relationship graph; executing, by the processor, the main query based on user interaction; displaying, by the processor, results for the main query; and overlaying, by the processor, one or more performance metrics.

The computer-implemented method may also include where determining the one or more query relationships includes: determining, by the processor, a first set of one or more sub-queries that are referenced by the main query. The computer-implemented method may also include parsing, by the processor, the main query. The computer-implemented method may also include collecting, by the processor, one or more referenced queries in a metadata. The computer-implemented method may also include loading, by the processor, a definition for each of the one or more referenced queries. The computer-implemented method may also include determining, by the processor, a set of one or more queries that reference the main query. The computer-implemented method may also include loading, by the processor, one or more containers. The computer-implemented method may also include examining, by the processor, the one or more containers. The computer-implemented method may also include where, for each query in each container, the method further includes parsing, by the processor, each query in each container, and determining, by the processor, whether the main query is referenced.

The computer-implemented method may also include where executing the main query includes: passing, by the processor, a unique query definition into a query execution engine, and executing, by the processor, the unique query definition.

The computer-implemented method may also include where displaying the results for the main query includes collecting, by the processor, data results from a query execution engine, and displaying, by the processor, the data results on a user interface.

The computer-implemented method may also include where overlaying the one or more performance metrics includes generating, by the processor, the one or more performance metrics, mapping, by the processor, each performance component to a corresponding query, and displaying, by the processor, the one or more performance metrics on at least one node and one link in the relationship graph. Other technical features may be readily apparent to one skilled in the art from the following figures, descriptions, and claims.

The computer-implemented method may also include where collecting the one or more referenced queries in the metadata includes examining, by the processor, stored metadata for one or more explicit references to one or more related objects, and using, by the processor, the metadata to retrieve the one or more related objects.

The computer-implemented method may also include where collecting the one or more referenced queries in the metadata includes reading, by the processor, the main query into a parsing engine built for language associated with the main query, using, by the processor, the parsing engine to convert the main query into an abstract syntax tree of one or more query-language tokens, matching, by the processor, one or more identifying tokens with one or more related objects, thereby populating the metadata, executing, by the processor, one or more functions on the one or more identifying tokens to match the one or more related objects, thereby populating the metadata, and using, by the processor, the metadata to retrieve the one or more related objects.

The computer-implemented method may also include where loading a query by reference includes loading, by the processor, a unique identifier associated with each of the one or more referenced queries.

The computer-implemented method may also include where displaying the relationship graph includes drawing, by the processor, a node on a graph representing the main query, with a left port for revealing a dependency relationship and a right port for revealing a usage relationship. Other technical features may be readily apparent to one skilled in the art from the following figures, descriptions, and claims.

In one aspect, a computing apparatus includes a processor. The computing apparatus also includes a memory storing instructions that, when executed by the processor, configure the apparatus to determine, by the processor, one or more query relationships for a main query, formula and/or expression, display, by the processor, a relationship graph, execute, by the processor, the main query based on user interaction, display, by the processor, results for the main query, and overlay, by the processor, one or more performance metrics.

The computing apparatus may also include where when determining the one or more query relationships, the apparatus is further configured to determine, by the processor, a first set of one or more sub-queries that are referenced by the main query. The computing apparatus may also include parse, by the processor, the main query. The computing apparatus may also include collect, by the processor, one or more referenced queries in a metadata. The computing apparatus may also include load, by the processor, a definition for each of the one or more referenced queries. The computing apparatus may also include determine, by the processor, a set of one or more queries that reference the main query. The computing apparatus may also include load, by the processor, one or more containers. The computing apparatus may also include examine, by the processor, the one or more containers. The computing apparatus may also include where, for each query in each container, the apparatus is further configured to parse, by the processor, each query in each container, and determine, by the processor, whether the main query is referenced.

The computing apparatus may also include where when executing the main query, the apparatus is further configured to pass, by the processor, a unique query definition into a query execution engine, and execute, by the processor, the unique query definition.

The computing apparatus may also include where when displaying the results for the main query, the apparatus is further configured to collect, by the processor, data results from a query execution engine, and display, by the processor, the data results on a user interface.

The computing apparatus may also include where when overlaying the one or more performance metrics, the apparatus is further configured to generate, by the processor, the one or more performance metrics, map, by the processor, each performance component to a corresponding query, and display, by the processor, the one or more performance metrics on at least one node and one link in the relationship graph. Other technical features may be readily apparent to one skilled in the art from the following figures, descriptions, and claims.

The computing apparatus may also include where when collecting the one or more referenced queries in the metadata, the apparatus is further configured to examine, by the processor, stored metadata for one or more explicit references to one or more related objects, and using, by the processor, the metadata to retrieve the one or more related objects.

The computing apparatus may also include where when collecting the one or more referenced queries in the metadata, the apparatus is further configured to read, by the processor, the main query into a parsing engine built for language associated with the main query, using, by the processor, the parsing engine to convert the main query into an abstract syntax tree of one or more query-language tokens, match, by the processor, one or more identifying tokens with one or more related objects, thereby populating the metadata, execute, by the processor, one or more functions on the one or more identifying tokens to match the one or more related objects, thereby populating the metadata, and using, by the processor, the metadata to retrieve the one or more related objects.

The computing apparatus may also include where when loading a query by reference, the apparatus is further configured to load, by the processor, a unique identifier associated with each of the one or more referenced queries.

The computing apparatus may also include where when displaying the relationship graph, the apparatus is further configured to draw, by the processor, a node on a graph representing the main query, with a left port for revealing a dependency relationship and a right port for revealing a usage relationship. Other technical features may be readily apparent to one skilled in the art from the following figures, descriptions, and claims.

In one aspect, a non-transitory computer-readable storage medium, the computer-readable storage medium including instructions that when executed by a computer, cause the computer to determine, by a processor, one or more query relationships for a main query, formula and/or expression, display, by the processor, a relationship graph, execute, by the processor, the main query based on user interaction, display, by the processor, results for the main query, and overlay, by the processor, one or more performance metrics.

The computer-readable storage medium may also include where when determining the one or more query relationships, the instructions that when executed by the computer, further cause the computer to determine, by the processor, a first set of one or more sub-queries that are referenced by the main query. The non-transitory computer-readable storage medium may also include parse, by the processor, the main query. The non-transitory computer-readable storage medium may also include collect, by the processor, one or more referenced queries in a metadata. The non-transitory computer-readable storage medium may also include load, by the processor, a definition for each of the one or more referenced queries. The non-transitory computer-readable storage medium may also include determine, by the processor, a set of one or more queries that reference the main query. The non-transitory computer-readable storage medium may also include load, by the processor, one or more containers. The non-transitory computer-readable storage medium may also include examine, by the processor, the one or more containers. The non-transitory computer-readable storage medium may also include where, for each query in each container, the computer is further configured to parse, by the processor, each query in each container, and determine, by the processor, whether the main query is referenced.

The computer-readable storage medium may also include where when executing the main query, the instructions that when executed by the computer, further cause the computer to pass, by the processor, a unique query definition into a query execution engine, and execute, by the processor, the unique query definition.

The computer-readable storage medium may also include where when displaying the results for the main query, the instructions that when executed by the computer, further cause the computer to collect, by the processor, data results from a query execution engine, and display, by the processor, the data results on a user interface.

The computer-readable storage medium may also include where when overlaying the one or more performance metrics, the instructions that when executed by the computer, further cause the computer to generate, by the processor, the one or more performance metrics, map, by the processor, each performance component to a corresponding query, and display, by the processor, the one or more performance metrics on at least one node and one link in the relationship graph. Other technical features may be readily apparent to one skilled in the art from the following figures, descriptions, and claims.

The computer-readable storage medium may also include where when collecting the one or more referenced queries in the metadata, the instructions that when executed by the computer, further cause the computer to examine, by the processor, stored metadata for one or more explicit references to one or more related objects, and using, by the processor, the metadata to retrieve the one or more related objects.

The computer-readable storage medium may also include where when collecting the one or more referenced queries in the metadata, the instructions that when executed by the computer, further cause the computer to read, by the processor, the main query into a parsing engine built for language associated with the main query, using, by the processor, the parsing engine to convert the main query into an abstract syntax tree of one or more query-language tokens, match, by the processor, one or more identifying tokens with one or more related objects, thereby populating the metadata, execute, by the processor, one or more functions on the one or more identifying tokens to match the one or more related objects, thereby populating the metadata, and using, by the processor, the metadata to retrieve the one or more related objects.

The computer-readable storage medium may also include where when loading a query by reference, the instructions that when executed by the computer, further cause the computer to load, by the processor, a unique identifier associated with each of the one or more referenced queries.

The computer-readable storage medium may also include where when displaying the relationship graph, the instructions that when executed by the computer, further cause the computer to draw, by the processor, a node on a graph representing the main query, with a left port for revealing a dependency relationship and a right port for revealing a usage relationship. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter will become apparent from the description, the drawings, and the claims.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for providing an entity relationship diagram in accordance with one embodiment.

FIG. 2 illustrates a block diagram in accordance with one embodiment.

FIG. 3 illustrates a block diagram for determining query relationships in accordance with one embodiment.

FIG. 4 illustrates a block diagram for finding a query reference in accordance with one embodiment.

FIG. 5 illustrates a block diagram for loading a query by reference in accordance with one embodiment.

FIG. 6 illustrates a block diagram for displaying a relationship graph in accordance with one embodiment.

FIG. 7 illustrates a block diagram for execution of a query in accordance with one embodiment.

FIG. 8 illustrates a block diagram for displaying results in accordance with one embodiment.

FIG. 9 illustrates a block diagram for overlaying performance metrics in a graph in accordance with one embodiment.

FIG. 10 illustrates a user's view while interacting with a user interface in accordance with one embodiment.

### DETAILED DESCRIPTION

Systems and methods for providing an interactive entity relationship diagram may comprise: a query parsing engine; a routine for discovering and loading related queries; a query relationships model; a query execution engine; and a user interface. The user interface integrating display and interaction for: a query entity relationship diagram; entity configuration controls; display of query results; and performance metrics overlay and display of supplementary performance details.

Construction of the entity relationship diagram can begin by selecting a query as a starting point. A routine for discovering related queries compiles metadata describing relationships, which populates the query relationships model, and loads the related queries. Some metadata can be explicitly stored within the query and related objects, while other metadata can be assembled by using a query parsing engine to resolve several methods within a syntax of establishing relationships dynamically.

Depending on user interaction, the query execution engine is employed to retrieve query results and performance metrics about those computations. All these elements can be integrated in a user interface which also provides the environment for configuring the queries and observing effects of the changes during the workflow.

To address user challenges, an interactive entity relationship diagram can automate the discovery of relationships among the component queries of an application. Through user interaction, the diagram can provide focused views for making changes in the same environment with awareness of the impact.

The diagram can enable users to select parts of the query structure to run during configuration and see the results; each sub-component of the structure may be evaluated as the user builds up a final result for consumption in the application. Through user interaction, the diagram can enable rapid exploration of sub-queries and the resulting data to review logic by seeing it in action and can facilitate corrections by observing errors where they occur.

A user aims to create efficient structures to achieve good technical performance in the final product. While executing sub-components, users can retrieve metrics about query calculation, and the graph can overlay performance data for each component in the query. Performance bottlenecks can be revealed immediately in the same environment where structure is visualized and amendments in the configuration may be affected.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

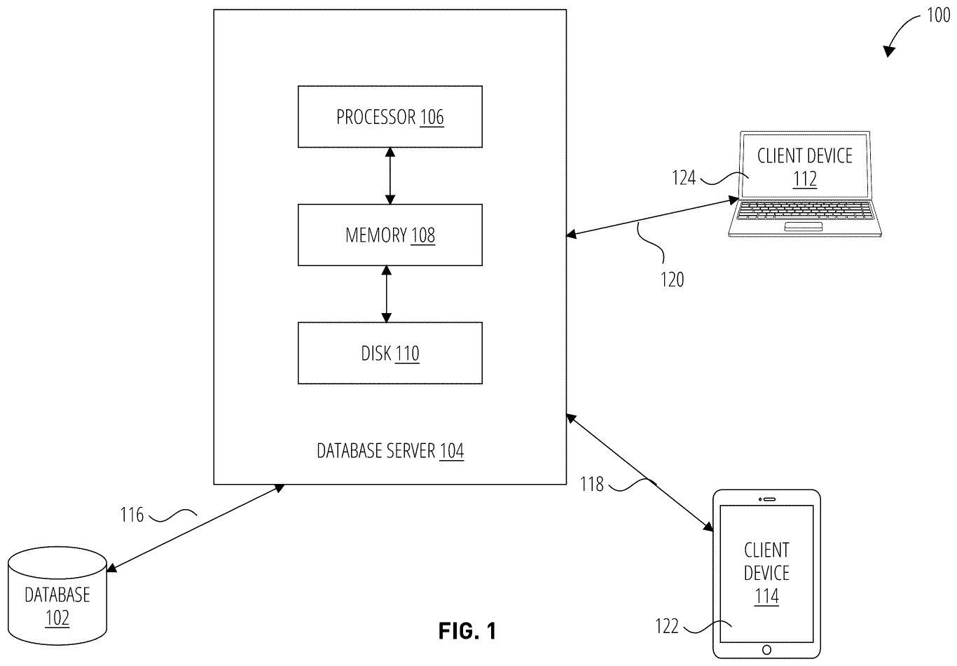

FIG. 1 illustrates an example of a system 100 for providing an entity relationship diagram,

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

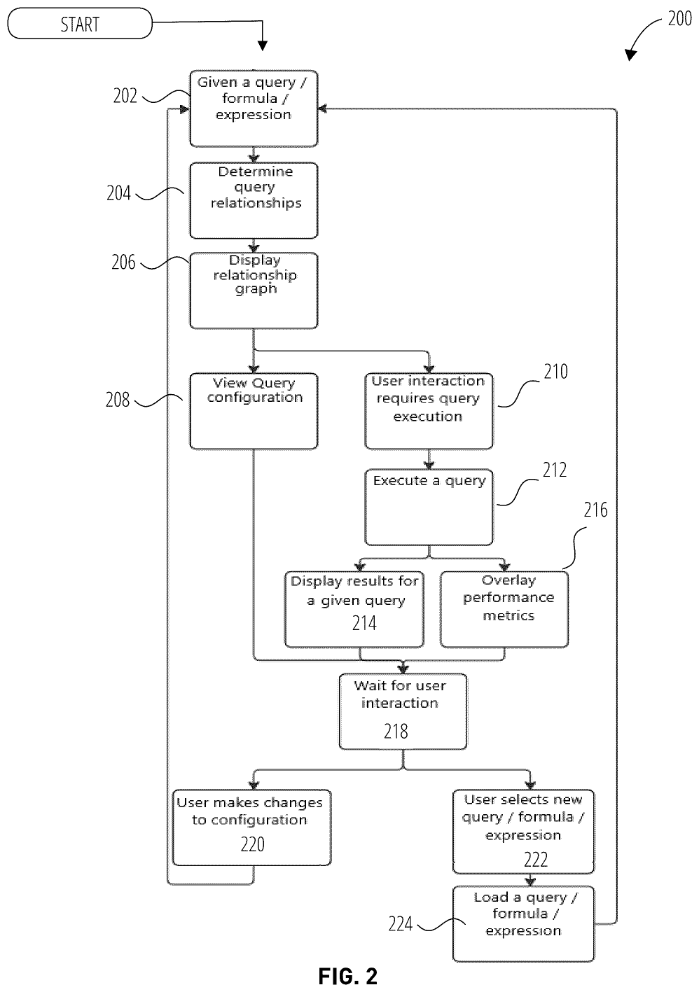

FIG. 2 illustrates a block diagram 200 in accordance with one embodiment.

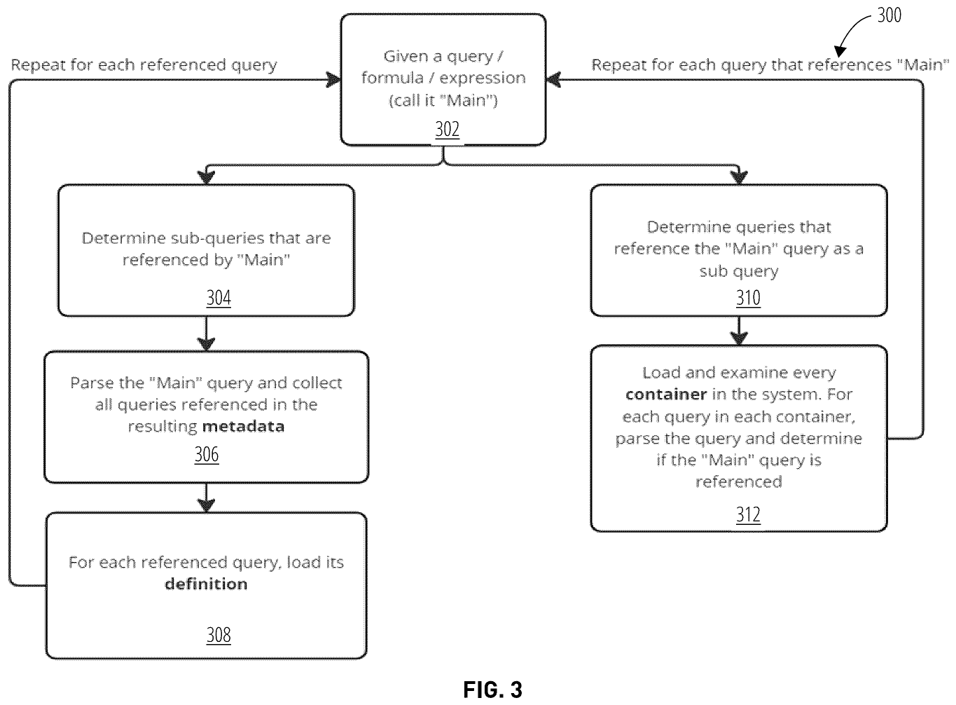

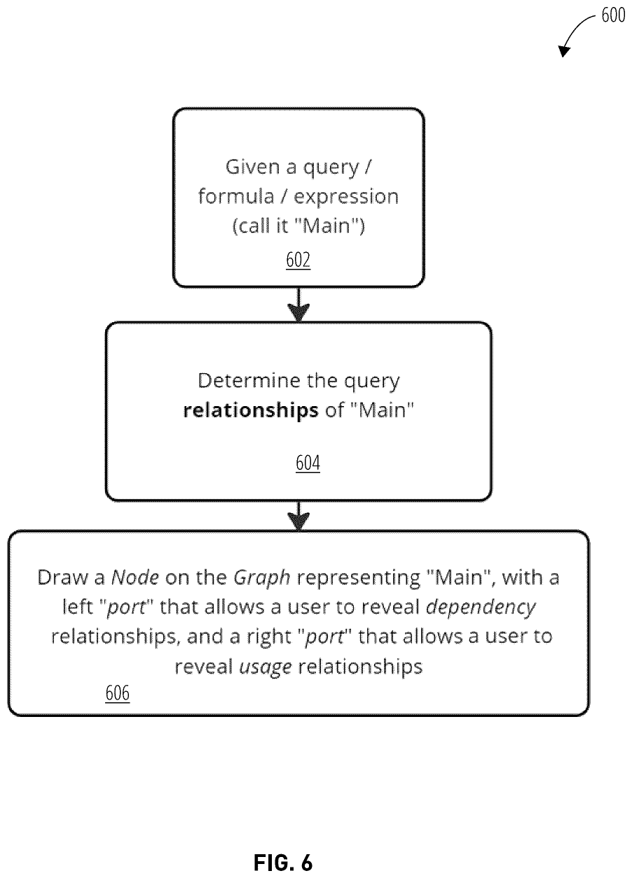

The process begins at block 202, with a given query/formula/expression. Next, query relationships may be determined at block 204 (see FIG. 3 for further elaboration). A relationship graph can be subsequently displayed at block 206 (see FIG. 6 for further elaboration).

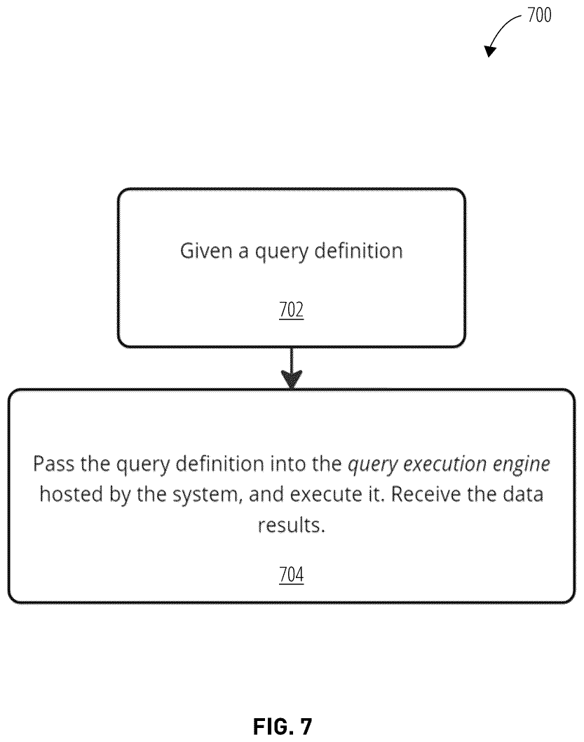

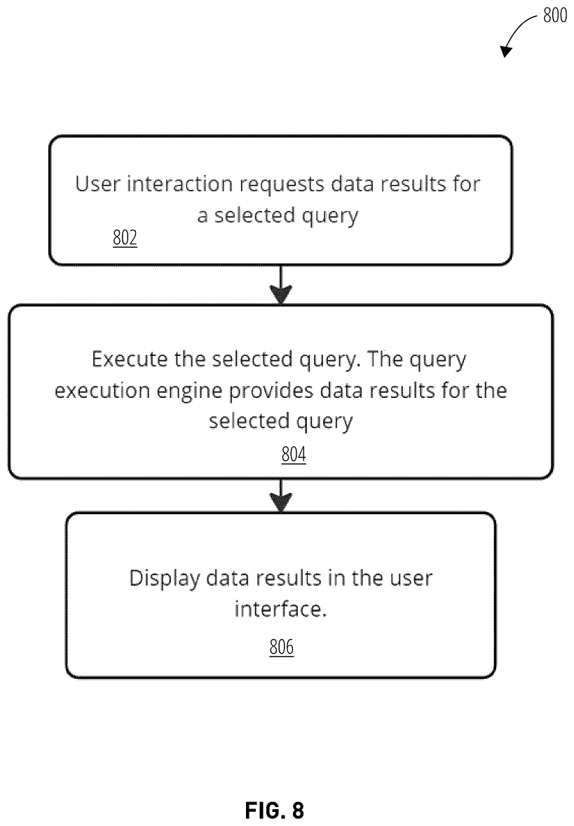

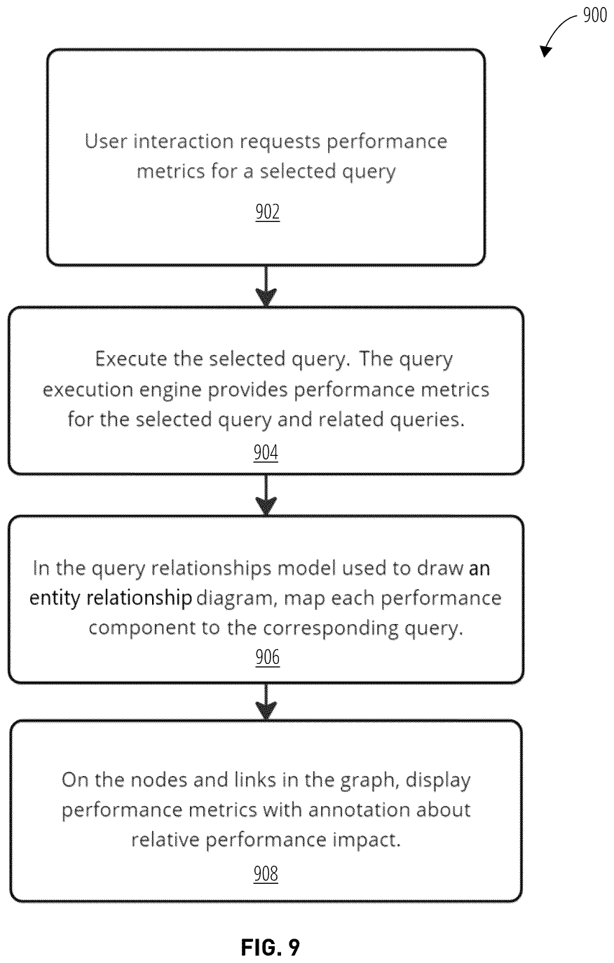

At this point, a user can view the query configuration at block 208, initiate interaction which requires query execution at block 210. The system, can also execute block 208 in parallel with block 210. If query configuration is viewed (block 208), then the system waits for user interaction at block 218. If, however, user interaction is initiated (block 210), then a query can be executed at block 212 (see FIG. 7 for further elaboration). This can result in a display of results for a given query at block 214 (see FIG. 8 for further elaboration) and/or an overlay of performance metrics at block 216 (see FIG. 9 for further elaboration). That is, block 214 can be executed in parallel with block 216. Alternatively, either block 214 or block 216 can be chosen for execution. The system may then wait for further user interaction at block 218.

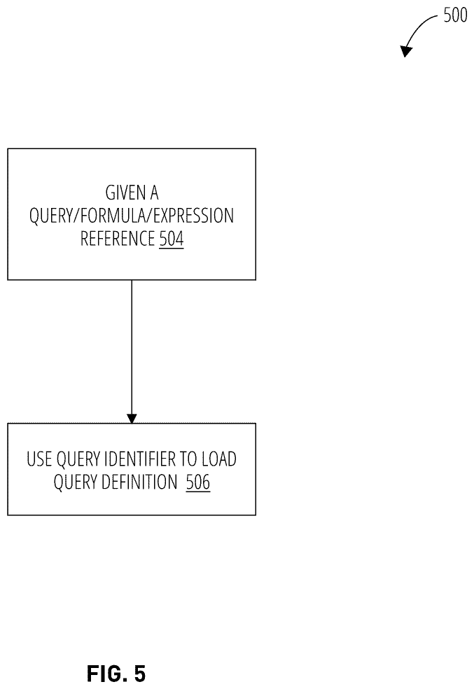

At this point, the user can make changes to the configuration at block 220, after which the process may resume at block 202. Alternatively, the user can select another query/formula/expression at block 222, after which the query/formula/expression can be loaded at block 224 (see FIG. 5 for further elaboration), after which the process may resume at block 202.

FIG. 3 illustrates a block diagram 300 for determining query relationships in accordance with one embodiment. The process begins at block 302, with a given query/formula/expression—which is called “Main” in the rest of the block diagram 300. It may then divide into two paths: one for sub-queries that are referenced by “Main” (block 304-block 308); and one for queries that reference the “Main” query as a sub-query (block 310-block 312).

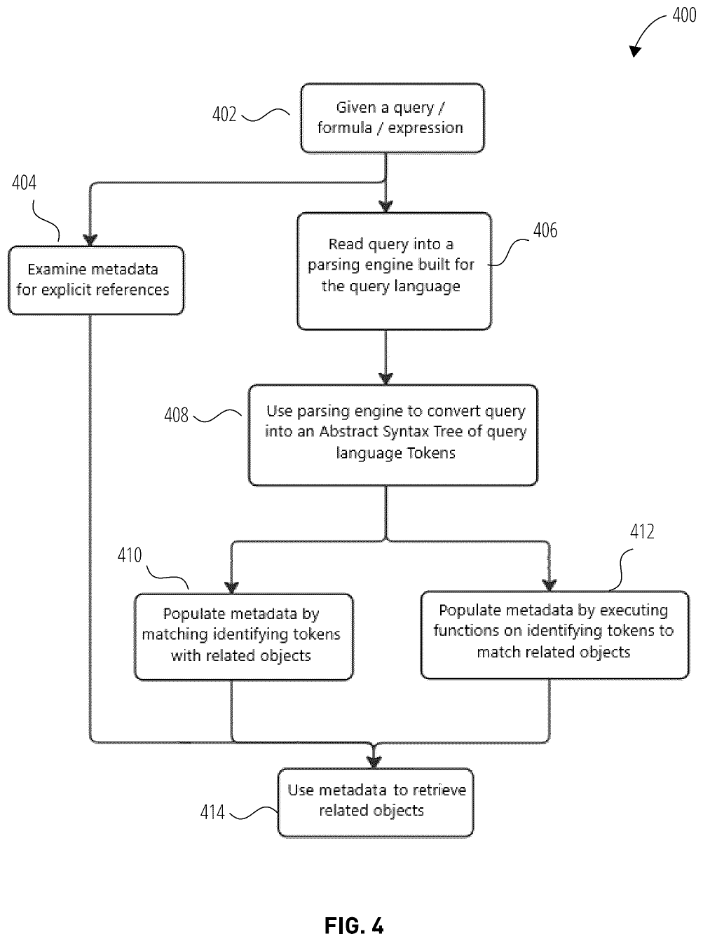

At block 304, sub-queries referenced by “Main”, can be determined. At block 306, the “Main” query can be parsed and all queries referenced in the resulting metadata may be collected (see FIG. 4). At block 306, the definition of each referenced query can be loaded (see FIG. 5). This can be repeated for each referenced query by reverting to block 302.

At block 310, queries that reference the “Main” query may be determined as a sub-query. Next, at block 312, every container can be loaded and examined in the system. For each query in each container, the query can be parsed and determined if the “Main” query is referenced (see FIG. 4). This process may be repeated for each query that references “Main” by reverting to block 302.

FIG. 4 illustrates a block diagram 400 for finding a query reference in accordance with one embodiment. The process begins at block 402, with a given query/formula/expression.

The routine for discovering related queries may compile metadata describing relationships, which populates a query relationships model, and loads related queries. Some metadata can be explicitly stored within the query and related objects (block 404), while other metadata can be assembled (block 406-block 412) by using a query parsing engine to resolve several methods within the syntax of establishing relationships dynamically.

Steps for assembling metadata may be as follows. At block 406, the query can be read into a parsing engine built for the query language. Next, at block 408, the parsing engine may be used to convert the query into an Abstract Syntax Tree of query language Tokens. As an example, “1+2” becomes “(expression (binary_expression ((IDENTIFIER 1) (OPERATOR+) (IDENTIFIER 2))))”. At block 410, metadata can be populated by matching identifying tokens with related objects. For example: (QUERY_REFERENCE ContainerA; QueryB; ColumnP) represents a direct reference to Column ‘P’ in Query ‘B’ in Container ‘A’. At block 412, metadata can be populated by executing functions on identifying tokens to match related objects. For example: (query_function (name LOOKUP)(argument ContainerA)). The metadata can then be used to retrieve related objects at block 414.

Alternatively, at block 404, stored metadata can be examined for explicit references to related objects. The metadata can then be used to retrieve related objects at block 414.

FIG. 5 illustrates a block diagram 500 for loading a query by reference in accordance with one embodiment. The process begins at block 504, with a given query/formula/expression. Each query reference may contain a unique identifier which describes where the query is defined—for example, which file/document/container the query is from. This identifier may be used to load the query definition from the system at block 506.

FIG. 6 illustrates a block diagram 600 for displaying a relationship graph in accordance with one embodiment. The process begins at block 602, with a given query/formula/expression—which is called “Main” in the rest of the block diagram 600. At block 604, the query relationships of “Main” may be determined (see FIG. 3). Next, at block 606, a node can be drawn on the graph that represents “Main”, with a left “port” that allows a user to reveal dependency relationships, and a right “port” that allows a user to reveal usage relationships.

FIG. 7 illustrates a block diagram 700 for execution of a query given a Graph Node (query item) in accordance with one embodiment. A query definition is given at block 702 (see FIG. 5). Next, at block 704, the query definition may be passed into the query execution engine hosted by the system, and executed. The data results are then received.

FIG. 8 illustrates a block diagram 800 for displaying results for any query or sub-query in a graph in accordance with one embodiment. At block 802, user interaction may result in a request for data results for a selected query. Next, at block 804, the selected query can be executed (see FIG. 7). The query execution engine may provide data results for the selected query. At block 806, the data results can be displayed in a user interface.

FIG. 9 illustrates a block diagram 900 for overlaying performance metrics in a graph in accordance with one embodiment.

At block 902, user interaction may result in a request for performance metrics for a selected query. Next, at block 904, the selected query can be executed (see FIG. 7). The query execution engine may provide performance metrics for the selected query and related queries. At block 906, in the query relationships model can be used to draw an entity relationship diagram, each performance component can be mapped to the corresponding query. At block 906, on the nodes and links in the graph, performance metrics may be displayed with annotation about relative performance impact.

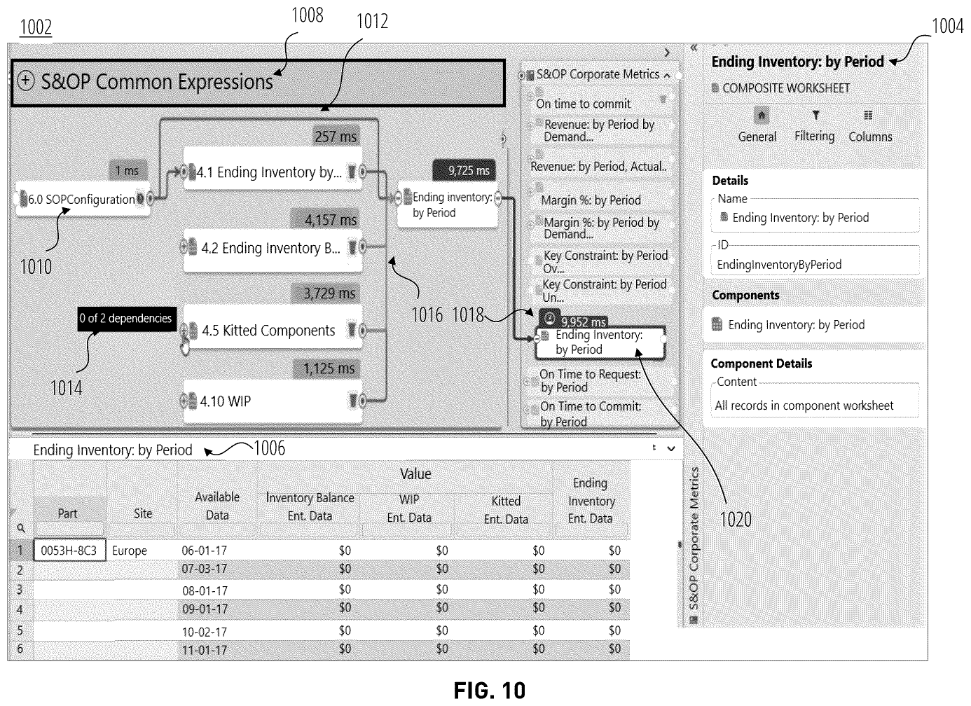

FIG. 10 illustrates a user's view while interacting with a user interface in accordance with one embodiment. The user may examine the structure of query components, change their configuration, and execute them to review results and performance.

In FIG. 10, 1002 represents an entity relationship diagram viewed by a user. Item 1004 represents an entity configuration UI. In FIG. 10, the entity shown is “ending inventory; by Period”. Item 1006 illustrates the query results UI, while 1008 shows a container hosting multiple query components. Item 1010 shows the query components, while 1012 illustrates a visualization of relationships among query components according to references in metadata and syntax. Item 1014 illustrates the UI enabling the user to explore, expand and collapse the diagram. Item 1016 illustrates a visualization (color code and display of metrics) of relative performance impact among component queries. Item 1018 illustrates an indicator on the query targeted for performance analysis, while 1020 illustrates an indication of the selected query, for which configuration and data results are displayed.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
determining, by a processor, one or more query relationships for a main query, formula and/or expression;
displaying, by the processor, a relationship graph;
executing, by the processor, the main query based on user interaction;
displaying, by the processor, results for the main query; and
overlaying, by the processor, one or more performance metrics.

2. The computer-implemented method of claim 1, wherein determining the one or more query relationships comprises:
determining, by the processor, a first set of one or more sub-queries that are referenced by the main query;
parsing, by the processor, the main query;
collecting, by the processor, one or more referenced queries in a metadata;
loading, by the processor, a definition for each of the one or more referenced queries;
determining, by the processor, a set of one or more queries that reference the main query;
loading, by the processor, one or more containers; and
examining, by the processor, the one or more containers;
wherein, for each query in each container, the method further comprises:
parsing, by the processor, each query in each container; and
determining, by the processor, whether the main query is referenced.

3. The computer-implemented method of claim 2, wherein collecting the one or more referenced queries in the metadata comprises:
examining, by the processor, stored metadata for one or more explicit references to one or more related objects; and
using, by the processor, the metadata to retrieve the one or more related objects.

4. The computer-implemented method of claim 2, wherein collecting the one or more referenced queries in the metadata comprises:
reading, by the processor, the main query into a parsing engine built for language associated with the main query;
using, by the processor, the parsing engine to convert the main query into an abstract syntax tree of one or more query-language tokens;
matching, by the processor, one or more identifying tokens with one or more related objects, thereby populating the metadata;
executing, by the processor, one or more functions on the one or more identifying tokens to match the one or more related objects, thereby populating the metadata; and
using, by the processor, the metadata to retrieve the one or more related objects.

5. The computer-implemented method of claim 2, wherein loading a query by reference comprises:
loading, by the processor, a unique identifier associated with each of the one or more referenced queries.

6. The computer-implemented method of claim 2, wherein displaying the relationship graph comprises:
drawing, by the processor, a node on a graph representing the main query, with a left port for revealing a dependency relationship and a right port for revealing a usage relationship.

7. The computer-implemented method of claim 1, wherein executing the main query comprises:
passing, by the processor, a unique query definition into a query execution engine; and
executing, by the processor, the unique query definition.

8. The computer-implemented method of claim 1, wherein displaying the results for the main query comprises:
collecting, by the processor, data results from a query execution engine; and
displaying, by the processor, the data results on a user interface.

9. The computer-implemented method of claim 1, wherein overlaying the one or more performance metrics comprises:
generating, by the processor, the one or more performance metrics;
mapping, by the processor, each performance component to a corresponding query; and
displaying, by the processor, the one or more performance metrics on at least one node and one link in the relationship graph.

10. A computing apparatus comprising:
a processor; and
a memory storing instructions that, when executed by the processor, configure the apparatus to:
determine, by the processor, one or more query relationships for a main query, formula and/or expression;
display, by the processor, a relationship graph;
execute, by the processor, the main query based on user interaction;
display, by the processor, results for the main query; and
overlay, by the processor, one or more performance metrics.

11. The computing apparatus of claim 10, wherein when determining the one or more query relationships, the apparatus is further configured to:
determine, by the processor, a first set of one or more sub-queries that are referenced by the main query;
parse, by the processor, the main query;
collect, by the processor, one or more referenced queries in a metadata;
load, by the processor, a definition for each of the one or more referenced queries;
determine, by the processor, a set of one or more queries that reference the main query;
load, by the processor, one or more containers; and
examine, by the processor, the one or more containers;
wherein, for each query in each container, the apparatus is further configured to:
parse, by the processor, each query in each container; and
determine, by the processor, whether the main query is referenced.

12. The computing apparatus of claim 11, wherein when collecting the one or more referenced queries in the metadata, the apparatus is further configured to:
examine, by the processor, stored metadata for one or more explicit references to one or more related objects; and
using, by the processor, the metadata to retrieve the one or more related objects.

13. The computing apparatus of claim 11, wherein when collecting the one or more referenced queries in the metadata, the apparatus is further configured to:
read, by the processor, the main query into a parsing engine built for language associated with the main query;
using, by the processor, the parsing engine to convert the main query into an abstract syntax tree of one or more query-language tokens;
match, by the processor, one or more identifying tokens with one or more related objects, thereby populating the metadata;
execute, by the processor, one or more functions on the one or more identifying tokens to match the one or more related objects, thereby populating the metadata; and
using, by the processor, the metadata to retrieve the one or more related objects.

14. The computing apparatus of claim 11, wherein when loading a query by reference, the apparatus is further configured to:
load, by the processor, a unique identifier associated with each of the one or more referenced queries.

15. The computing apparatus of claim 11, wherein when displaying the relationship graph, the apparatus is further configured to:
draw, by the processor, a node on a graph representing the main query, with a left port for revealing a dependency relationship and a right port for revealing a usage relationship.

16. The computing apparatus of claim 10, wherein when executing the main query, the apparatus is further configured to:
pass, by the processor, a unique query definition into a query execution engine; and
execute, by the processor, the unique query definition.

17. The computing apparatus of claim 10, wherein when displaying the results for the main query, the apparatus is further configured to:
collect, by the processor, data results from a query execution engine; and
display, by the processor, the data results on a user interface.

18. The computing apparatus of claim 10, wherein when overlaying the one or more performance metrics, the apparatus is further configured to:
generate, by the processor, the one or more performance metrics;
map, by the processor, each performance component to a corresponding query; and
display, by the processor, the one or more performance metrics on at least one node and one link in the relationship graph.

19. A non-transitory computer-readable storage medium, the computer-readable storage medium including instructions that when executed by a computer, cause the computer to:
determine, by a processor, one or more query relationships for a main query, formula and/or expression;
display, by the processor, a relationship graph;
execute, by the processor, the main query based on user interaction;
display, by the processor, results for the main query; and
overlay, by the processor, one or more performance metrics.

20. The computer-readable storage medium of claim 19, wherein when determining the one or more query relationships, the instructions that when executed by the computer, further cause the computer to:
determine, by the processor, a first set of one or more sub-queries that are referenced by the main query;
parse, by the processor, the main query;
collect, by the processor, one or more referenced queries in a metadata;
load, by the processor, a definition for each of the one or more referenced queries;
determine, by the processor, a set of one or more queries that reference the main query;
load, by the processor, one or more containers; and
examine, by the processor, the one or more containers;
wherein, for each query in each container, the computer is further configured to:
parse, by the processor, each query in each container; and
determine, by the processor, whether the main query is referenced.

21. The computer-readable storage medium of claim 20, wherein when collecting the one or more referenced queries in the metadata, the instructions that when executed by the computer, further cause the computer to:
examine, by the processor, stored metadata for one or more explicit references to one or more related objects; and
using, by the processor, the metadata to retrieve the one or more related objects.

22. The computer-readable storage medium of claim 20, wherein when collecting the one or more referenced queries in the metadata, the instructions that when executed by the computer, further cause the computer to:
read, by the processor, the main query into a parsing engine built for language associated with the main query;
using, by the processor, the parsing engine to convert the main query into an abstract syntax tree of one or more query-language tokens;
match, by the processor, one or more identifying tokens with one or more related objects, thereby populating the metadata;
execute, by the processor, one or more functions on the one or more identifying tokens to match the one or more related objects, thereby populating the metadata; and
using, by the processor, the metadata to retrieve the one or more related objects.

23. The computer-readable storage medium of claim 20, wherein when loading a query by reference, the instructions that when executed by the computer, further cause the computer to:
load, by the processor, a unique identifier associated with each of the one or more referenced queries.

24. The computer-readable storage medium of claim 20, wherein when displaying the relationship graph, the instructions that when executed by the computer, further cause the computer to:
draw, by the processor, a node on a graph representing the main query, with a left port for revealing a dependency relationship and a right port for revealing a usage relationship.

25. The computer-readable storage medium of claim 19, wherein when executing the main query, the instructions that when executed by the computer, further cause the computer to:
pass, by the processor, a unique query definition into a query execution engine; and
execute, by the processor, the unique query definition.

26. The computer-readable storage medium of claim 19, wherein when displaying the results for the main query, the instructions that when executed by the computer, further cause the computer to:
collect, by the processor, data results from a query execution engine; and
display, by the processor, the data results on a user interface.

27. The computer-readable storage medium of claim 19, wherein when overlaying the one or more performance metrics, the instructions that when executed by the computer, further cause the computer to:
generate, by the processor, the one or more performance metrics;
map, by the processor, each performance component to a corresponding query; and
display, by the processor, the one or more performance metrics on at least one node and one link in the relationship graph.
